(19) United States
(12) Patent Application Publication
(10) Pub. No.: US 2018/0209921 A1
(43) Pub. Date: Jul. 26, 2018

(54) SYSTEMS AND METHODS FOR ASSAYING AN ELUATE OF A RADIONUCLIDE GENERATOR

(71) Applicant: Mallinckrodt Nuclear Medicine LLC, Hazelwood, MO (US)

(72) Inventors: Bryan S. Petrofsky, St. Louis, MO (US); Kevin B. Graves, Catawissa, MO (US); Sumit Verma, Chesterfield, MO (US); John Schmitz, St. Charles, MO (US); Michael J. D'Hooge, Bridgeton, MO (US)

(21) Appl. No.: 15/410,994

(22) Filed: Jan. 20, 2017

(51) Int. Cl. G01N 23/00

(52) U.S. Cl. CPC G01N 23/00; G01N 2223/636; G01N 2223/202

(57) ABSTRACT

A system for assaying an eluate includes a radiation detection device, a fluid handling system, and a connection interface. The radiation detection device includes a collection reservoir, and is adapted to measure a radioactive content of a sample within the collection reservoir. The fluid handling system includes a fluid supply line, a suction line, and a fluid discharge line, each connected to the collection reservoir. The connection interface connects a radionuclide generator to the collection reservoir via the fluid handling system. The fluid handling system is configured to generate a negative pressure within the collection reservoir via the suction line such that an eluate from the radionuclide generator is supplied to the collection reservoir via the fluid supply line.

### FIELD

The field of the disclosure relates generally to radionuclide generators and, more particularly, to systems of methods for assaying an eluate of a radionuclide generator.

### BACKGROUND

Molybdenum-99 (Mo-99) is the parent radioisotope used for generating Technetium-99m (Tc-99m) for diagnostic medical purposes. Specifically, quantities up to 6000 Curies (Ci) can be used to produce Technetium generators. Accordingly, samples from the formulation process must be tested (i.e., assayed) for Molybdenum-99 content.

Conventional assaying methods use liquid transfer vials or containers to elute the Technetium generator, and subsequently transfer the vial or container to a radiation detection device to measure or assay the radioactive content of the eluate. The use of transfer vials or containers has several drawbacks including additional costs of manufacturing sterile evacuated vials, and additional costs and processing associated with disposing of the vial after the assay process is complete. Accordingly, a need exists for improved systems and methods for assaying radionuclide generators.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a system for assaying an eluate includes a radiation detection device, a fluid handling system, and a connection interface. The radiation detection device includes a collection reservoir, and is adapted to measure a radioactive content of a sample within the collection reservoir. The fluid handling system includes a fluid supply line, a suction line, and a fluid discharge line, each connected to the collection reservoir. The connection interface connects a radionuclide generator to the collection reservoir via the fluid handling system. The fluid handling system is configured to generate a negative pressure within the collection reservoir via the suction line such that an eluate from the radionuclide generator is supplied to the collection reservoir via the fluid supply line.

In another aspect, a method of assaying an eluate includes connecting a radionuclide generator to a connection interface of a fluid handling system. The fluid handling system includes a fluid supply line, a suction line, and a fluid discharge line, each connected to a collection reservoir of a radiation detection device. The method further includes eluting the radionuclide generator to produce an eluate, where eluting the radionuclide generator includes generating a negative pressure within the collection reservoir via the suction line. The method further includes directing the eluate into the collection reservoir via the fluid supply line, determining, using a processor, a radioactive content of the eluate, and discharging the eluate from the collection reservoir via the fluid discharge line.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic view of a system for producing radionuclide generators.

FIG. 2 is a perspective view of a radionuclide generator.

FIG. 3 is a schematic view of an example assay system suitable for use in the system of FIG. 1.

FIG. 4 is a block diagram of a controller included in the assay system of FIG. 3.

FIG. 5 is a top plan view of another embodiment of an example assay system suitable for use in the system of FIG. 1.

FIG. 6 is a perspective view of a portion of the assay system shown in FIG. 5.

FIG. 7 is a top plan view of a fluid handling subsystem of the assay system shown in FIG. 5.

FIG. 8 is a sectional view of a portion of a radiation detection device included in the assay system of FIG. 5.

Corresponding reference characters indicate corresponding parts throughout the several views of the drawings.

### DETAILED DESCRIPTION

Radioactive material is used in nuclear medicine for diagnostic and therapeutic purposes by injecting a patient with a small dose of the radioactive material, which concentrates in certain organs or regions of the patient. Radioactive materials typically used for nuclear medicine include Technetium-99m (“Tc-99m”), Indium-111m (“In-111”), Thallium-201, and Strontium-87m, among others.

Such radioactive materials may be produced using a radionuclide generator. Radionuclide generators generally include a column that has media for retaining a long-lived parent radionuclide that spontaneously decays into a daughter radionuclide that has a relatively short half-life. The column may be incorporated into a column assembly that has a needle-like outlet port that receives an evacuated vial to draw saline or other eluant liquid, provided to a needle-like inlet port, through a flow path of the column assembly, including the column itself. This liquid may elute and deliver daughter radionuclide from the column and to the evacuated vial for subsequent use in nuclear medical imaging applications, among other uses.

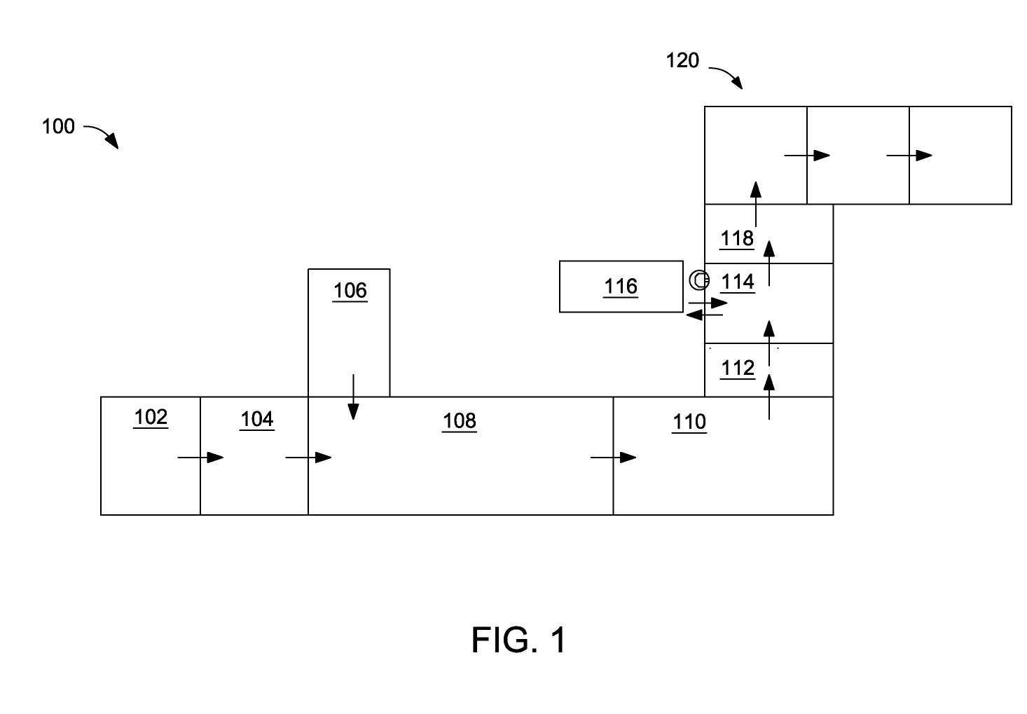

FIG. 1 is a schematic view of a system 100 for manufacturing radionuclide generators. The system 100 shown in FIG. 1 may be used to produce various radionuclide generators, including, for example and without limitation, Technetium generators, Indium generators, and Strontium generators. The system 100 of FIG. 1 is particularly suited for producing Technetium generators. A Technetium generator is a pharmaceutical drug and device used to create sterile injectable solutions containing Tc-99m, an agent used in diagnostic imaging with a relatively short 6 hour radiological half-life, allowing the Tc-99m to be relatively quickly eliminated from human tissue. Tc-99m is “generated” via the natural decay of Molybdenum (“Mo-99”), which has a 66 hour half-life, which is desirable because it gives the generator a relatively long two week shelf life. During generator operation (i.e., elution with a saline solution), Mo-99 remains chemically bound to a core alumina bed (i.e., a retaining media) packed within the generator column, while Tc-99m washes free into an elution vial, ready for injection into a patient. While the system 100 is described herein with reference to Technetium generators, it is understood that the system 100 may be used to produce radionuclide generators other than Technetium generators.

As shown in FIG. 1, the system 100 generally includes a plurality of stations. In the example embodiment, the system 100 includes a cask loading station 102, a formulation station 104, an activation station 106, a fill/wash station 108, an assay/autoclave loading station 110, an autoclave station 112, an autoclave unloading station 114, a quality control testing station 116, a shielding station 118, and a packaging station 120.

The cask loading station 102 is configured to receive and handle casks or containers of radioactive material, such as a parent radionuclide, and transfer the radioactive material to the formulation station 104. Radioactive material may be transported in secondary containment vessels and flasks that need to be removed from an outer cask prior to formulation. The cask loading station 102 includes suitable tooling and mechanisms to extract secondary containment vessels and flasks from outer casks, as well as transfer of flasks to the formulation cell. Suitable devices that may be used in the cask loading station 102 include, for example and without limitation, telemanipulators.

At the formulation station 104, the raw radioactive material (i.e., Mo-99) is quality control tested, chemically treated if necessary, and then pH adjusted while diluting the raw radioactive material to a desired final target concentration. The formulated radioactive material is stored in a suitable containment vessel (e.g., within the formulation station 104).

Column assemblies containing a column of retaining media (e.g., alumina) are activated at the activation station 106 to facilitate binding of the formulated radioactive material with the retaining media. In some embodiments, column assemblies are activated by eluting the column assemblies with a suitable volume of HCl at a suitable pH level. Column assemblies are held for a minimum wait time prior to charging the column assemblies with the parent radionuclide.

Following activation, column assemblies are loaded into the fill/wash station 108 using a suitable transfer mechanism (e.g., transfer drawer). Each column assembly is then charged with parent radionuclide by eluting formulated radioactive solution (e.g., Mo-99) from the formulation station 104 through individual column assemblies using suitable liquid handling systems (e.g., pumps, valves, etc.). The volume of formulated radioactive solution eluted through each column assembly is based on the desired Ci activity for the corresponding column assembly. The volume eluted through each column assembly is equivalent to the total Ci activity identified at the time of calibration for the column assembly. For example, if a volume of formulated Mo-99 required to make a 1.0 Ci generator (at time of calibration) is ‘X’, the volume required to make a 19.0 Ci generator is simply 19 times X. After a minimum wait time, the charged column assemblies are eluted with a suitable volume and concentration of acetic acid, followed by an elution with a suitable volume and concentration of saline to “wash” the column assemblies. Column assemblies are held for a minimum wait time before performing assays on the column assemblies.

The charged and washed column assemblies (or radionuclide generators) are then transferred to the assay/autoclave load station 110, in which assays are taken from each column assembly to check the amount of parent and daughter radionuclide produced during elution. Each column assembly is eluted with a suitable volume of saline, and the resulting solution is assayed to check the parent and daughter radionuclide levels in the assay. Where the radioactive material is Mo-99, the elutions are assayed for both Tc-99m and Mo-99. Column assemblies having a daughter radionuclide (e.g., Tc-99m) assay falling outside an acceptable range calculation are rejected. Column assemblies having a parent radionuclide (e.g., Mo-99) breakthrough exceeding a maximum acceptable limit are also rejected. As described further herein, systems and methods of the present disclosure facilitate assaying elutions of radionuclide generators without the use of transfer vials or other liquid containers that require transfer to a radiation detection device. For example, embodiments of the systems and methods described herein facilitate eluting a radionuclide generator directly into the collection reservoir of a radiation detection device.

Following the assay process, tip caps are applied to the outlet port and the fill port of the column assembly. Column assemblies may be provided with tip caps already applied to the inlet port. If the column assembly is not provided with a tip cap pre-applied to the inlet port, a tip cap may be applied prior to, subsequent to, or concurrently with tip caps being applied to the outlet port and the fill port. Assayed, tip-capped column assemblies are then loaded into an autoclave sterilizer located in the autoclave station 112 for terminal sterilization. The sealed column assemblies are subjected to an autoclave sterilization process within the autoclave station 112 to produce terminally-sterilized column assemblies.

Following the autoclave sterilization cycle, column assemblies are unloaded from the autoclave station 112 into the autoclave unloading station 114. Column assemblies are then transferred to the shielding station 118 for shielding.

Some of the column assemblies are transferred to the quality control testing station 116 for quality control. In the example embodiment, the quality control testing station 116 includes a QC testing isolator that is sanitized prior to QC testing, and maintained at a positive pressure and a Grade A clean room environment to minimize possible sources of contamination. Column assemblies are aseptically eluted for in-process QC sampling, and subjected to sterility testing within the isolator of the quality control testing station 116. Tip caps are reapplied to the inlet and outlet needles of the column assemblies before the column assemblies are transferred back to the autoclave unloading station 114.

The system 100 includes a suitable transfer mechanism for transferring column assemblies from the autoclave unloading station 114 (which is maintained at a negative pressure differential, Grade B clean room environment) to the isolator of the quality control testing station 116. In some embodiments, column assemblies subjected to quality control testing may be transferred from the quality control testing station 116 back to the autoclave unloading station 114, and can be re-sterilized and re-tested, or re-sterilized and packaged for shipment. In other embodiments, column assemblies are discarded after being subjected to QC testing.

In the shielding station 118, column assemblies from the autoclave unloading station 114 are visually inspected for container closure part presence, and then placed within a radiation shielding container (e.g., a lead plug). The radiation shielding container is inserted into an appropriate safe constructed of suitable radiation shielding material (e.g., lead, tungsten or depleted uranium). Shielded column assemblies are then released from the shielding station 118.

In the packaging station 120, shielded column assemblies from the shielding station 118 are placed in buckets pre-labeled with appropriate regulatory (e.g., FDA) labels. A label uniquely identifying each generator is also printed and applied to each bucket. A hood is then applied to each bucket. A handle is then applied to each hood.

The system 100 may generally include any suitable transport systems and devices to facilitate transferring column assemblies between stations. In some embodiments, for example, each of the stations includes at least one telemanipulator to allow an operator outside the hot cell environment (i.e., within the surrounding room or lab) to manipulate and transfer column assemblies within the hot cell environment. Moreover, in some embodiments, the system 100 includes a conveyance system to automatically transport column assemblies between the stations and/or between substations within one or more of the stations (e.g., between a fill substation and a wash substation within the fill/wash station 108).

In the example embodiment, some stations of the system 100 include and/or are enclosed within a shielded nuclear radiation containment chamber, also referred to herein as a “hot cell”. Hot cells generally include an enclosure constructed of nuclear radiation shielding material designed to shield the surrounding environment from nuclear radiation. Suitable shielding materials from which hot cells may be constructed include, for example and without limitation, lead, depleted uranium, and tungsten. In some embodiments, hot cells are constructed of steel-clad lead walls forming a cuboid or rectangular prism. In some embodiments, a hot cell may include a viewing window constructed of a transparent shielding material. Suitable materials from which viewing windows may be constructed include, for example and without limitation, lead glass. In the example embodiment, each of the cask loading station 102, the formulation station 104, the fill/wash station 108, the assay/autoclave loading station 110, the autoclave station 112, the autoclave unloading station 114, and the shielding station 118 include and/or are enclosed within a hot cell.

In some embodiments, one or more of the stations are maintained at a certain clean room grade (e.g., Grade B or Grade C). In the example embodiment, pre-autoclave hot cells (i.e., the cask loading station 102, the formulation station 104, the fill/wash station 108, the assay/autoclave loading station 110) are maintained at a Grade C clean room environment, and the autoclave unloading cell or station 114 is maintained at a Grade B clean room environment. The shielding station 118 is maintained at a Grade C clean room environment. The packaging stations 120 are maintained at a Grade D clean room environment. Unless otherwise indicated, references to clean room classifications refer to clean room classifications according to Annex 1 of the European Union Guidelines to Good Manufacturing Practice.

Additionally, the pressure within one or more stations of the system 100 may be controlled at a negative or positive pressure differential relative to the surrounding environment and/or relative to adjacent cells or stations. In some embodiments, for example, all hot cells are maintained at a negative pressure relative to the surrounding environment. Moreover, in some embodiments, the isolator of the quality control testing station 116 is maintained at a positive pressure relative to the surrounding environment and/or relative to adjacent stations of the system 100 (e.g., relative to the autoclave unloading station 114).

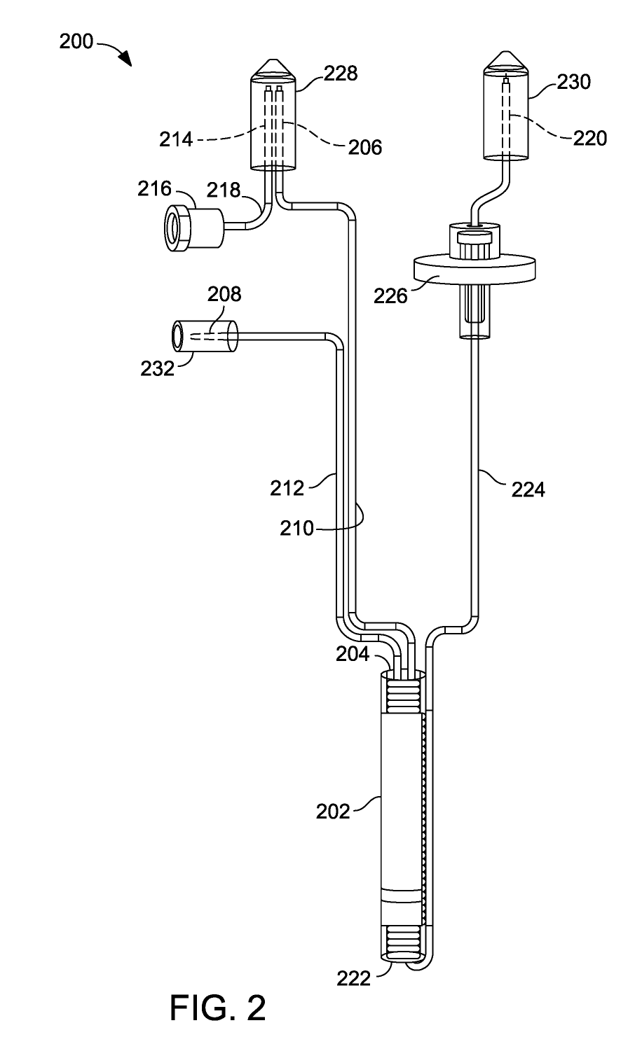

FIG. 2 is a perspective view of an example radionuclide generator 200 (specifically, an elution column assembly of a radionuclide generator) that may be produced with the system 100. As shown in FIG. 2, the radionuclide generator 200 includes an elution column 202 fluidly connected at a top end 204 to an inlet port 206 and a charge port (also referred to herein as a fill port or, more generally, an inlet port) 208 through an inlet line 210 and a charge line 212, respectively. A vent port 214 that communicates fluidly with an eluant vent 216 via a venting conduit 218 is positioned adjacent to the inlet port 206, and may, in operation, provide a vent to a vial or bottle of eluant connected to the inlet port 206. The radionuclide generator 200 also includes an outlet port 220 that is fluidly connected to a bottom end 222 of the column 202 through an outlet line 224. A filter assembly 226 is incorporated into the outlet line 224. The column 202 defines a column interior that includes a retaining media (e.g., alumina beads, not shown). As described above, during production of the radionuclide generator 200, the column 202 is charged via the charge port 208 with a radioactive material, such as Molybdenum-99, which is retained with the interior of the column 202 by the retaining media. The radioactive material retained by the retaining media is also referred to herein as the “parent radionuclide”.

During use of the radionuclide generator 200, an eluant vial (not shown) containing an eluant fluid (e.g., saline) is connected to the inlet port 206 by piercing a septum of the eluant vial with the needle-like inlet port 206. An evacuated elution vial (not shown) is connected to the outlet port 220 by piercing a septum of the elution vial with the needle-like outlet port 220. Eluant fluid from the eluant vial is drawn through the elution line, and elutes the column 202 containing parent radionuclide (e.g., Mo-99). The negative pressure of the evacuated vial draws eluant from the eluant vial and through the flow pathway, including the column, to elute daughter radionuclide (e.g., Tc-99m) for delivery through the outlet port 220 and to the elution vial. The eluant vent 216 allows air to enter the eluant vial through the vent port 214 to prevent a negative pressure within the eluant vial that might otherwise impede the flow of eluant through the flow pathway. After having eluted daughter radionuclide from the column 202, the elution vial is removed from the outlet port 220.

The radionuclide generator 200 shown in FIG. 2 is shown in a finally assembled state. In particular, the radionuclide generator 200 includes an inlet cap 228, an outlet cap 230, and a charge port cap 232. The caps 228, 230, 232 protect respective ports 206, 214, 220, and 208, and inhibit contaminants from entering the radionuclide generator 200 via the needles.

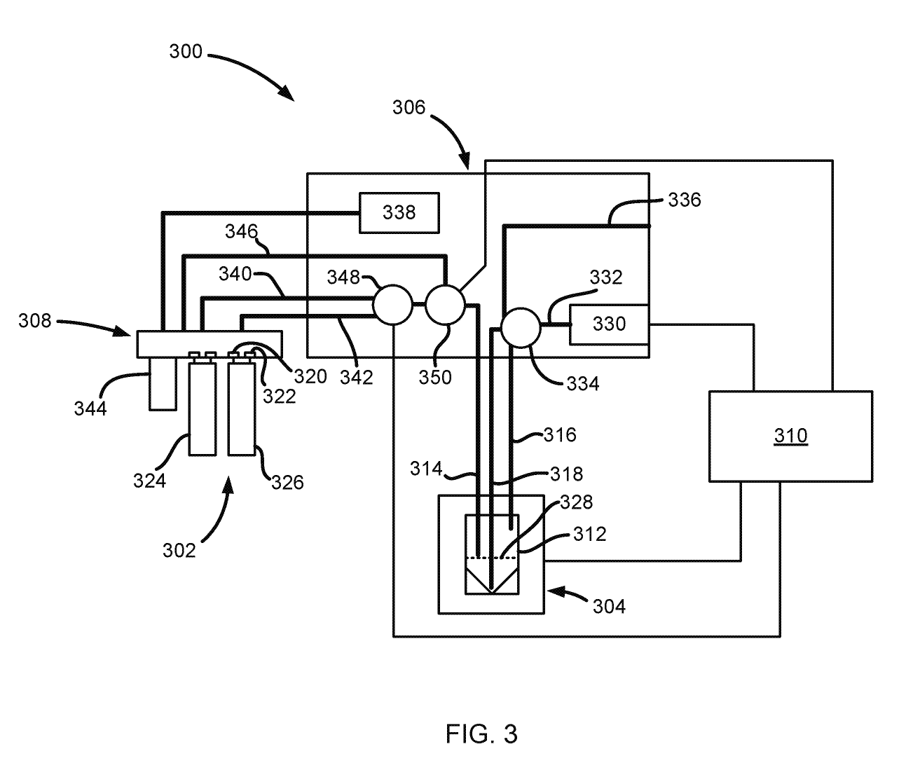

FIG. 3 is a schematic view of an example assay system 300 for assaying radionuclide generators 302, such as the radionuclide generator 200 shown in FIG. 2. The assay system 300 may be housed, for example, within the assay/autoclave loading station 110 and, more specifically, within a hot cell of the assay/autoclave loading station 110.

The assay system 300 includes a radiation detection device 304, a fluid handling system 306, a connection interface 308, and a computing device or controller 310. As described further herein, the assay system 300 facilitates connecting radionuclide generators 302 directly to the radiation detection device 304 (i.e., without any intervening or intermediate transfer vials or containers) for delivering eluates directly to the radiation detection device 304.

The radiation detection device 304 includes a collection reservoir 312, and is configured to measure a radioactive content of a sample within the collection reservoir 312. The radiation detection device 304 may have any suitable configuration that enables the assay system 300 to function as described herein. In this embodiment, the radiation detection device 304 is a dual, concentric ionization chamber. One suitable embodiment of a dual, concentric ionization chamber is described, for example, in U.S. patent application Ser. No. 15/203,452, filed Jul. 6, 2016, the disclosure of which is hereby incorporated by reference in its entirety. In this embodiment, the radiation detection device 304 is configured to detect and/or measure electric current within first and second ionization chambers of the radiation detection device 304 that correspond to a radioactive content of a sample within the collection reservoir 312. The controller 310 is configured to determine a radioactive content of the sample based on the current measurements.

The fluid handling system 306 is configured to deliver fluid (e.g., eluate) to the collection reservoir 312. In particular, the fluid handling system 306 includes a fluid supply line 314, a suction line 316, and a fluid discharge line 318, each fluidly connected to the collection reservoir 312. As described in more detail herein, the fluid handling system 306 is configured generate a negative pressure within the collection reservoir 312 via the suction line 316 such that an eluate from one of the radionuclide generators 302 is supplied to the collection reservoir 312 via the fluid supply line 314.

The connection interface 308 is configured to fluidly connect at least one radionuclide generator 302, such as the radionuclide generator 200 shown in FIG. 2, to the collection reservoir 312 via the fluid handling system 306 such that eluate from the radionuclide generator 302 can be delivered to the collection reservoir 312 via the fluid handling system 306. The connection interface 308 includes an inlet port 320 for connecting to an inlet of a radionuclide generator 302 (e.g., inlet port 206 and/or charge port 208) and an outlet port 322 for connecting to an outlet of the radionuclide generator 302 (e.g., outlet port 220). The inlet and outlet ports 320, 322 may include, for example, septa that are punctured or pierced by needle-like inlets and outlets of the radionuclide generators 302. In this embodiment, the connection interface 308 is configured for connection to two radionuclide generators 302, including a first radionuclide generator 324 and a second radionuclide generator 326. In particular, the connection interface 308 includes two inlet ports 320 and two outlet ports 322. In other embodiments, the connection interface 308 may be configured for connection to more than or less than two radionuclide generators. In some embodiments, for example, the connection interface 308 is configured for connection to up to eight radionuclide generators.

The controller 310 is connected to the radiation detection device 304 and components of the fluid handling system 306. The controller 310 is configured to control components of the fluid handling system 306 to effect delivery of an eluate from the radionuclide generators 302 to the collection reservoir 312, and to determine a radioactive content of the eluate within the collection reservoir 312 based on measurements taken by the radiation detection device 304. While the controller 310 is shown separate from other components of the assay system 300 in FIG. 3, it should be understood that components of the controller (e.g., one or more processors) may be located or integrated within other components of the assay system 300. In some embodiments, for example, a processor of the controller 310 is integrated within the radiation detection device 304 for determining the radioactive content of a sample within the collection reservoir 312.

As shown in FIG. 3, each of the fluid supply line 314, the suction line 316, and the fluid discharge line 318 extend into the collection reservoir 312 of the radiation detection device 304. Moreover, the fluid supply line 314, the suction line 316, and the fluid discharge line 318 extend to varying depths within the collection reservoir 312. Specifically, the fluid discharge line 318 extends to the lowest depth and adjacent a lower surface of the collection reservoir 312 to facilitate removing fluids from the collection reservoir 312. The suction line 316 extends to the highest (i.e., shallowest) depth, and is positioned above a liquid reference line or plane 328 to inhibit liquid from being aspirated into the suction line 316. The fluid supply line 314 extends to a depth intermediate the suction line 316 and the fluid discharge line 318.

In this embodiment, the fluid handling system 306 includes a plurality of other fluid handling components for controlling the supply and discharge of fluids to and from the collection reservoir 312. For example, in the example embodiment, the fluid handling system 306 includes a vacuum pump 330, a common discharge line 332, and a first valve 334 that provides selective fluid communication between the vacuum pump 330 and each of the suction line 316 and the fluid discharge line 318 for performing the fluid handling operations describes herein. In this embodiment, the fluid handling system 306 uses a common vacuum pump 330 to generate suction in the suction line 316 and to draw fluids through fluid discharge line 318. In other embodiments, the fluid handling system 306 may include separate, dedicated pumps and associated fluid handling lines for each of the suction line 316 and the fluid discharge line 318. Additionally, in some embodiments, the vacuum pump 330 may be connected to one or more liquid waste tanks in which radioactive liquid discharged from the collection reservoir 312 is stored.

The vacuum pump 330 may have any suitable pump configuration that enables the fluid handling system 306 to function as described herein. For example, the vacuum pump 330 may generally include, without limitation, any vacuum pump capable of generating regulated, sustained vacuum levels of 20 in Hg or less.

The vacuum pump 330 is connected to the first valve 334 by the common discharge line 332. The fluid discharge line 318 and the suction line 316 are also each connected to the first valve 334. In the example embodiment, the first valve 334 is a multi-port, multi-way valve that can be actuated between a plurality of different valve configurations to provide selective fluid communication between the fluid discharge line 318 and the vacuum pump 330, and selective fluid communication between the suction line 316 and the vacuum pump 330. For example, the first valve 334 can be actuated between a first valve configuration, in which the vacuum pump 330 is connected in fluid communication with the suction line 316, and a second valve configuration, in which the vacuum pump 330 is connected in fluid communication with the fluid discharge line 318.

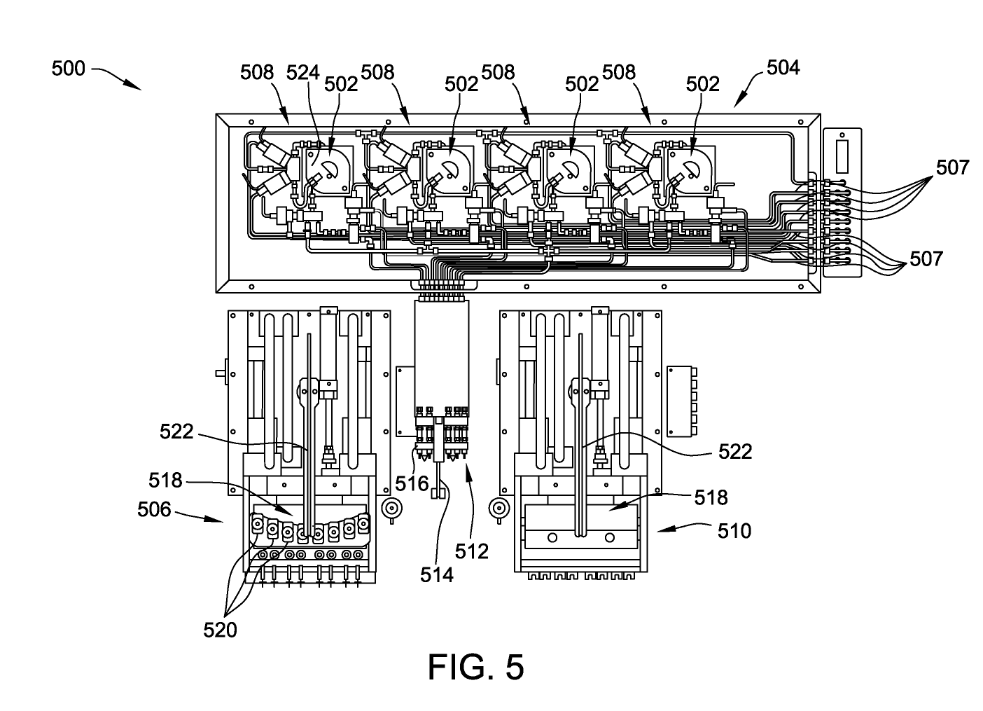

Further, in the example embodiment, the fluid handling system 306 includes a vent line 336 that is selectively connectable to the fluid discharge line 318 by actuation of the first valve 334. In particular, in the example embodiment, the first valve 334 can be actuated to a third valve configuration in which the vent line 336 is connected in fluid communication with the fluid discharge line 318, and the vacuum pump 330 is simultaneously connected in fluid communication with suction line 316. The vent line 336 provides fluid communication between the fluid discharge line 318 and an external environment that has a pressure equal to or greater than the pressure within the collection reservoir 312. Thus, when the vacuum pump 330 is activated and the first valve 334 is in the third valve configuration (i.e., the vacuum pump 330 is connected to the suction line 316 and the vent line 336 is connected to the fluid discharge line 318) gas (e.g., air) is drawn through the vent line 336 and into the collection reservoir 312 via the fluid discharge line 318. Other embodiments, such as the embodiment shown in FIGS. 5-7, may not include a vent line 336.

In the example embodiment, the fluid handling system 306 also includes an eluant fluid source 338, a plurality of eluate supply lines including a first eluate supply line 340 and a second eluate supply line 342, a rinsing fluid reservoir 344, a rinsing fluid supply line 346, a second valve 348, and a third valve 350.

The eluant fluid source 338 is connected to the connection interface 308 for supplying eluant fluid (e.g., saline) to each of the radionuclide generators 302 during elution. The eluant fluid source 338 may include, for example, one or more fluid reservoirs for holding the eluant fluid, a pump, and a fluid conduit for supplying eluant fluid to the one or more fluid reservoirs. The fluid reservoirs may include, for example and without limitation, a syringe barrel. The pump may have any suitable known pump configuration for pumping eluant fluid through the fluid conduit to fluid reservoir. In one embodiment, the pump is a peristaltic pump.

The fluid reservoirs of the eluant fluid source 338 may be connected in fluid communication with the radionuclide generators 302 via the connection interface 308. In one embodiment, for example, the inlet of each radionuclide generator 302 is connected to a corresponding fluid reservoir of the eluant fluid source 338 via the connection interface 308.

The first and second eluate supply lines 340, 342 are connected to the connection interface 308 for supplying eluate from a corresponding one of the radionuclide generators 302 connected thereto. The first and second eluate supply lines 340, 342 extend from the connection interface 308, and are connected to the second valve 348.

The second valve 348 is connected between each of the first and second eluate supply lines 340, 342 and the fluid supply line 314 for providing selective fluid communication between the first and second eluate supply lines 340, 342 and the fluid supply line 314. The second valve 348 can be actuated to a first valve configuration in which fluid (specifically, eluate) from the first eluate supply line 340 is permitted to pass through the second valve 348, and fluid from the second eluate supply line is inhibited from passing through the second valve 348. The second valve 348 can also be actuated to a second valve configuration in which fluid (specifically, eluate) from the second eluate supply line 342 is permitted to pass through the second valve 348, and fluid from the first eluate supply line is inhibited from passing through the second valve 348.

In the example embodiment, the third valve 350 is also connected between the first and second eluate supply lines 340, 342 and the fluid supply line 314. More specifically, the third valve 350 is connected between the second valve 348 and the fluid supply line 314. Thus, in the example embodiment, the first and second eluate supply lines 340, 342 are selectively connectable to the fluid supply line 314 by actuation of the second valve 348 and the third valve 350 to supply eluate to the collection reservoir 312 from different radionuclide generators. In other embodiments, the first and second eluate supply lines 340, 342 may be selectively connectable to the fluid supply line 314 by actuation of only a single valve (e.g., second valve 348) to supply eluate to the collection reservoir from different radionuclide generators.

The third valve 350 is also connected between the rinsing fluid supply line 346 and the fluid supply line 314 to provide selective fluid communication between the rinsing fluid supply line 346 and the fluid supply line 314. More specifically, the third valve 350 can be actuated to a first valve configuration, in which fluid from the rinsing fluid supply line 346 is permitted to pass through the third valve 350, and a second valve configuration, in which fluid from one of the first and second eluate supply lines 340, 342 is permitted to pass through the third valve 350.

The rinsing fluid supply line 346 is also connected to the rinsing fluid reservoir 344. In this embodiment, the rinsing fluid supply line 346 is connected to the rinsing fluid reservoir 344 via the connection interface 308. The rinsing fluid reservoir 344 may include, for example and without limitation, a syringe barrel. Suitable rinsing fluids that may be stored in the rinsing fluid reservoir 344 and used to rinse the collection reservoir 312 include, for example and without limitation, saline. In some embodiments, the rinsing fluid is the same fluid as the eluant fluid supplied by the eluant fluid source 338.

The first valve 334, the second valve 348, and the third valve 350 may have any suitable valve configurations that enable the fluid handling system 306 to function as described herein, including, for example and without limitation, pneumatically-actuated valves and electrically-actuated valves. In the example embodiment, each of the first valve 334, the second valve 348, and the third valve 350 is a pneumatically-actuated valve connected to suitable pressurized gas source and the controller 310 to control operation of the valves. The controller 310 is configured to control each of the first valve 334, the second valve 348, and the third valve 350 by outputting control signals to the respective valve, and thereby cause actuation of the respective valve. Pneumatically-actuated valves suitable for use as the first valve 334, the second valve 348, and the third valve 350 include, for example and without limitation, Swagelok three-way valve model number SS-41GXES2-51D sold by Swagelok Company. In some embodiments, the first valve 334 includes more than one valve, and may include, for example, two two-way valves or two three-way valves. In some embodiments, for example, the first valve 334 may include two Swagelok two-way valves, model number SS-92S2-C-NF-SI, or two Swagelok three-way valves, model number SS-41GXES2-51D.

The controller 310 is connected to each of the vacuum pump 330, the first valve 334, the second valve 348, and the third valve 350 to control operation of the respective components to deliver fluids to the collection reservoir 312. The controller 310 is further connected to the radiation detection device 304 for receiving measurement data or values associated with a radioactive content of a sample (e.g., eluate) within the collection reservoir 312.

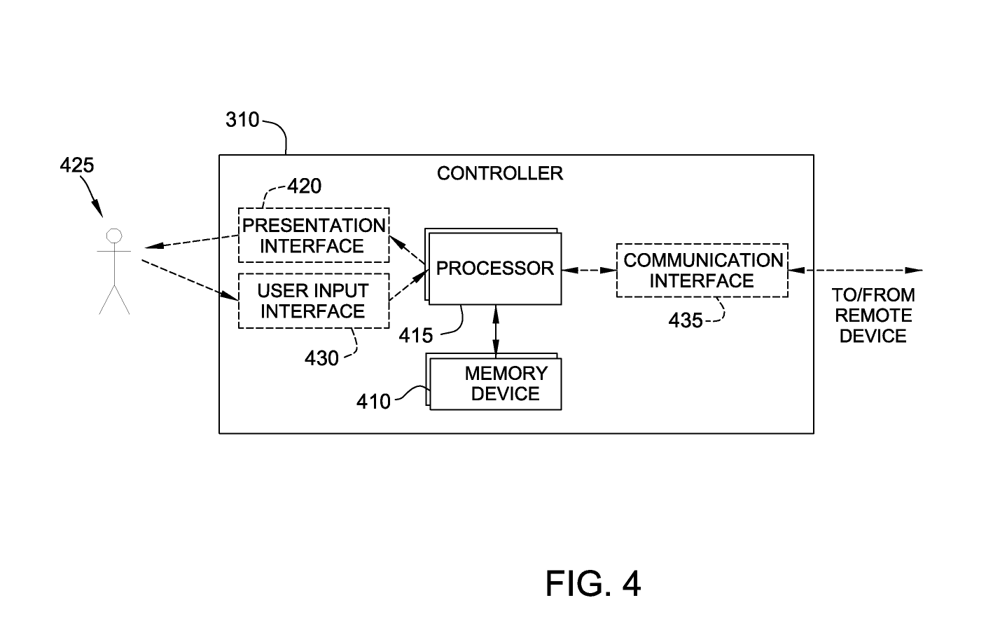

FIG. 4 is a block diagram of the controller 310. The controller 310 includes at least one memory device 410 and a processor 415 that is coupled to the memory device 410 for executing instructions. In this embodiment, executable instructions are stored in the memory device 410, and the controller 310 performs one or more operations described herein by programming the processor 415. For example, the processor 415 may be programmed by encoding an operation as one or more executable instructions and by providing the executable instructions in the memory device 410.

The processor 415 may include one or more processing units (e.g., in a multi-core configuration). Further, the processor 415 may be implemented using one or more heterogeneous processor systems in which a main processor is present with secondary processors on a single chip. As another illustrative example, the processor 415 may be a symmetric multi-processor system containing multiple processors of the same type. Further, the processor 415 may be implemented using any suitable programmable circuit including one or more systems and microcontrollers, microprocessors, programmable logic controllers (PLCs), reduced instruction set circuits (RISC), application specific integrated circuits (ASIC), programmable logic circuits, field programmable gate arrays (FPGA), and any other circuit capable of executing the functions described herein. In this embodiment, the processor 415 controls operation of the fluid handling system 306 by outputting control signals to components of the fluid handling system 306, as described herein. Further, in this embodiment, the processor 415 determines a radioactive content of a sample within the collection reservoir 312 based on data or measurements collected by the radiation detection device 304.

The memory device 410 is one or more devices that enable information such as executable instructions and/or other data to be stored and retrieved. The memory device 410 may include one or more computer readable media, such as, without limitation, dynamic random access memory (DRAM), static random access memory (SRAM), a solid state disk, and/or a hard disk. The memory device 410 may be configured to store, without limitation, application source code, application object code, source code portions of interest, object code portions of interest, configuration data, execution events and/or any other type of data.

In this embodiment, the controller 310 includes a presentation interface 420 that is connected to the processor 415. The presentation interface 420 presents information, such as application source code and/or execution events, to a user 425, such as a technician or operator. For example, the presentation interface 420 may include a display adapter (not shown) that may be coupled to a display device, such as a cathode ray tube (CRT), a liquid crystal display (LCD), an organic LED (OLED) display, and/or an “electronic ink” display. The presentation interface 420 may include one or more display devices. In this embodiment, the presentation interface 420 displays the determined radioactive content of a sample within the collection reservoir 312, such as a Molybdenum-99 content and/or a Technetium-99m content.

The controller 310 also includes a user input interface 430 in this embodiment. The user input interface 430 is connected to the processor 415 and receives input from the user 425. The user input interface 430 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of the presentation interface 420 and the user input interface 430.

In this embodiment, the controller 310 further includes a communication interface 435 connected to the processor 415. The communication interface 435 communicates with one or more remote devices, such as the fluid handling system 306 and the radiation detection device 304.

In operation, the radionuclide generators 302 are connected to the fluid handling system 306 via the connection interface 308, and are eluted directly into the collection reservoir 312 (i.e., without any intervening transfer vials or containers) to measure or assay the eluate of each radionuclide generator 302.

The radionuclide generators 302 may be connected to the connection interface 308 by manually moving or manipulating the radionuclide generators 302 to a position adjacent the connection interface 308 using, for example, telemanipulators. In some embodiments, the radionuclide generators 302 are connected to the connection interface 308 by piercing inlet and outlet septa of the connection interface 308 with corresponding inlet and outlet needles of each of the radionuclide generators 302. Further, in this embodiment, the radionuclide generators 302 are concurrently connected to the connection interface 308.

The controller 310 controls operation of the fluid handling system 306 to elute the radionuclide generators 302, and deliver eluates to the collection reservoir 312. In this embodiment, the controller 310 controls operation of the first valve 334, the second valve 348, the third valve 350, and the vacuum pump 330 to sequentially elute the first and second radionuclide generators 324, 326 into the collection reservoir 312, and to remove or discharge fluids from the collection reservoir 312 between sequential elutions.

Specifically, in this embodiment, the controller 310 actuates each of the second valve 348 and the third valve 350 to respective valve configurations such that the first eluate supply line 340 is connected in fluid communication with the collection reservoir 312 via the fluid supply line 314. The controller 310 further actuates the first valve 334 to a valve configuration such that the vacuum pump 330 is connected in fluid communication with the suction line 316, and thereby configured to generate a negative pressure within the collection reservoir 312 via the suction line 316. The controller 310 then activates the vacuum pump 330 to generate a negative pressure within or evacuate the collection reservoir 312 via the suction line 316. The negative pressure within the collection reservoir 312 causes eluant fluid from the eluant fluid source 338 to be drawn through the first radionuclide generator 324 to elute the first radionuclide generator 324. The resulting eluate is drawn or directed through the first eluate supply line 340 and the fluid supply line 314 into the evacuated collection reservoir 312.

In this embodiment, the controller 310 elutes the first radionuclide generator 324 until a predetermined or fixed volume of eluant fluid is drawn through the first radionuclide generator 324. The volume of eluant fluid drawn through the first radionuclide generator 324 may be in the range of, for example, 1 milliliter (mL) to 50 mL, 2 mL to 75 mL, 5 mL to 25 mL, 5 mL to 15 mL, 7 mL to 35 mL, 7 mL to 15 mL, and 10 mL to 20 mL.

The controller 310 activates the vacuum pump 330 until the entire volume of eluant fluid is drawn through the first radionuclide generator 324. Once the elution is complete, the controller 310 deactivates the vacuum pump 330. In some embodiments, the fluid handling system 306 may include one or more sensors connected to the controller 310 for detecting or determining when the entire volume of eluant fluid has been drawn through the first radionuclide generator 324. In some embodiments, for example, the fluid handling system 306 includes a bubble or gas sensor connected to the first eluate supply line 340 to detect bubbles or gas within the first eluate supply line 340. The presence of gas or bubbles within the first eluate supply line 340 indicates that the fixed volume of fluid has been drawn through the first radionuclide generator 324, and there is little or none of the fixed volume of eluant fluid remaining. The fluid handling system 306 may include similar sensors connected to the second eluate supply line 342.

When elution of the first radionuclide generator 324 is complete, the radiation detection device 304 measures the radioactive content of the eluate within the collection reservoir 312. In this embodiment, the radiation detection device 304 measures the radioactive content of the eluate by measuring electric current values in one or more ionization chambers of the radiation detection device 304, where the magnitude of the measured current corresponds to the radioactive content of the eluate. The controller 310 determines the radioactive content of the eluate (e.g., a Molybdenum-99 content and/or a Technetium-99m content) based on the current values measured by the radiation detection device 304.

The eluate from the first radionuclide generator 324 is removed or discharged from the collection reservoir 312 prior to elution of the second radionuclide generator 326. Specifically, in this embodiment, the controller actuates the first valve 334 to a valve configuration in which the vacuum pump 330 is connected in fluid communication with the fluid discharge line 318, and activates the vacuum pump 330 to aspirate eluate within the collection reservoir 312 into the fluid discharge line 318. Fluids from the fluid discharge line 318 are directed to a radioactive liquid waste container for further processing and disposal. In some embodiments, the vent line 336 may also be connected in fluid communication with the suction line 316 (via the first valve 334) during removal of liquid from the collection reservoir 312 to facilitate removal of liquid from the collection reservoir 312.

The second radionuclide generator 326 is assayed in the same manner as the first radionuclide generator 324, except the second valve 348 is actuated to a valve configuration in which the second eluate supply line 342 is connected in fluid communication with the fluid supply line 314. The controller 310 then controls operation of the fluid handling system 306 and the radiation detection device 304 to elute the second radionuclide generator 326 into the collection reservoir 312, and assay the eluate of the second radionuclide generator 326. If the assay results of one or more of the radionuclide generators 302 are out of specification (e.g., not within a predefined range), the radionuclide generator may be pulled from the production line for further processing, analysis, and/or disposal.

In some embodiments, the radiation detection device 304 may be calibrated or “tared” between subsequent elutions to account for background radiation that may be present in the radiation detection device 304. For example, after an assay sample is removed from the collection reservoir 312, the empty collection reservoir 312 is assayed for Tc-99m and Mo-99 content. The measured values may be stored (e.g., in the memory device 415) and then used as a baseline or “tare” for the subsequent elution analysis.

In some embodiments, the collection reservoir 312 may be washed or rinsed with a rinsing fluid (e.g., saline), for example, in between elutions of different radionuclide generators or after a batch of radionuclide generators have been assayed. In this embodiment, for example, following elution of one or more radionuclide generators into the collection reservoir 312, the controller 310 actuates the third valve 350 to a valve configuration in which the rinsing fluid supply line 346 is connected in fluid communication with the fluid supply line 314, and actuates the first valve 334 to a valve configuration in which the vacuum pump 330 is connected in fluid communication with the suction line 316. The controller 310 then activates the vacuum pump 330 to generate a negative pressure within the collection reservoir 312, thereby drawing rinsing fluid from the rinsing fluid reservoir 344 through the rinsing fluid supply line 346 and the fluid supply line 314, and into the collection reservoir 312.

Further, in this embodiment, after the rinsing fluid is delivered to the collection reservoir 312, the controller 310 controls the fluid handling system 306 to draw gas bubbles through the rinsing fluid to agitate the rinsing fluid and facilitate cleaning of the collection reservoir 312. Specifically, the controller 310 actuates the first valve 334 to a valve configuration in which the fluid discharge line 318 is connected in fluid communication with the vent line 336, and in which the vacuum pump 330 is connected in fluid communication with the suction line 316. The controller 310 then activates the vacuum pump 330 to generate a negative pressure within the collection reservoir 312, thereby drawing gas (e.g., air) through the vent line 336 and the fluid discharge line 318, and through the rinsing fluid within the collection reservoir 312. The rinsing fluid is subsequently removed from the collection reservoir 312 by connecting the fluid discharge line 318 to the vacuum pump 330, and activating the vacuum pump 330 to aspirate the rinsing fluid into the fluid discharge line 318.

FIG. 5 is a top plan view of another embodiment of an example assay system 500 suitable for use in a radionuclide generator manufacturing system, such as the system 100 shown in FIG. 1. The assay system of FIG. 5 includes components similar to the components of the assay system 300 shown and described above with reference to FIG. 3. For example, the assay system 500 includes a radiation detection device 502, a fluid handling system 504, a connection interface 506, and a controller (not shown in FIG. 5). Additionally, the assay system 500 includes a plurality of pneumatic supply lines 507 for supplying pressurized gas to pneumatically-actuated valves of the assay system 500.

In this embodiment, the assay system 500 is designed to assay multiple radionuclide generators at the same time (i.e., simultaneously). Specifically, the assay system 500 includes a plurality of the radiation detection devices 502 and a plurality of fluid handling subsystems 508, each configured to control the supply of fluid (e.g., eluate) to and from a respective one of the radiation detection devices 502. The example embodiment includes four radiation detection devices 502, and four fluid handling subsystems 508. Other embodiments may include more or less than four radiation detection devices 502 and four fluid handling subsystems 508. Further, in this embodiment, each fluid handling subsystem 508 is configured to supply an eluate from two different radionuclide generators to a common radiation detection device 502. In other embodiments, one or more of the fluid handling subsystems 508 may be configured to supply an eluate from more than or less than two radionuclide generators to a radiation detection device.

The assay system 500 of FIG. 5 also includes a secondary or redundant connection interface 510 that is selectively connectable to the fluid handling system 504 via a connection block 512 connected to a lever arm 514. In operation, only one of the connection interface 506 and the secondary connection interface 510 is connected to the fluid handling system 504 via the connection block 512.

Further, in this embodiment, the connection block 512 includes a disposable portion 516 that is connected to the connection interface 506 (specifically, outlet ports of the connection interface 506) via disposable tubing, such as silicone tubing (not shown in FIG. 5). The disposable portion 516 and disposable tubing are designed to be discarded after a batch of radionuclide generators (e.g., eight) is assayed with the assay system 500.

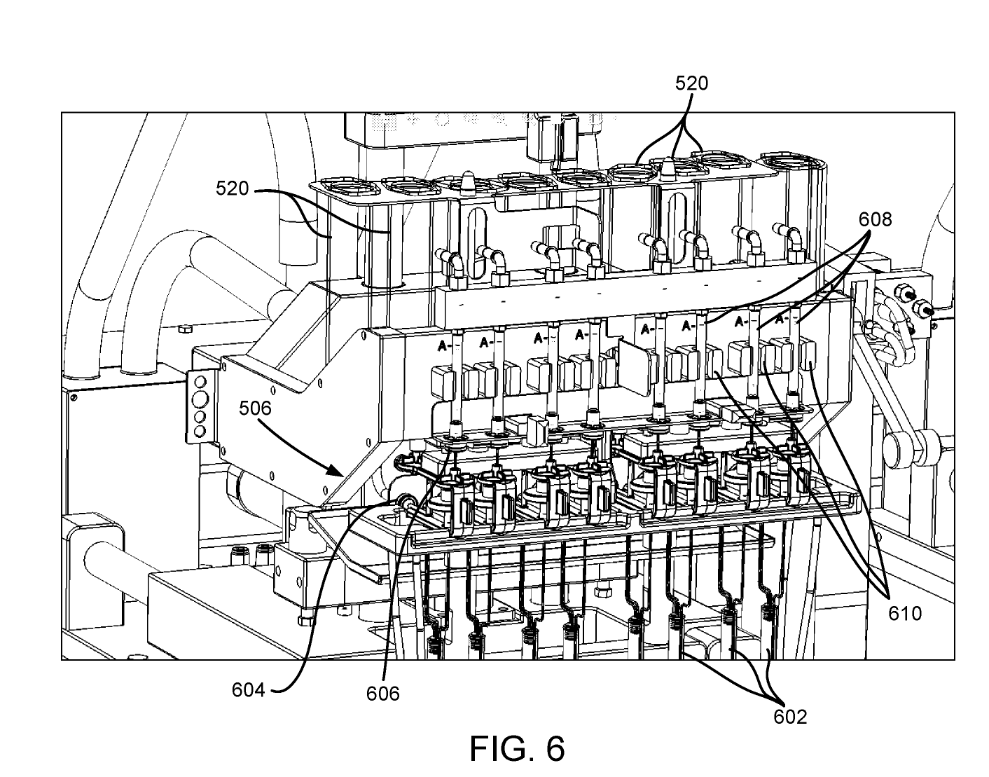

FIG. 6 is a perspective view of the connection interface 506 of the assay system 500 shown in FIG. 5. The secondary connection interface 510 has an identical configuration to the connection interface 506. The connection interface 506 is configured to fluidly connect a plurality of radionuclide generators 602 to the collection reservoirs of the radiation detection devices 502 such that eluate from the radionuclide generators 602 can be directly delivered to the collection reservoirs via the fluid handling system 504. As shown in FIG. 6, in this embodiment, the connection interface 506 is configured for connection to eight radionuclide generators 602. Specifically, the connection interface 506 includes eight inlet ports 604 for connecting to the inlet of a radionuclide generator, and eight outlet ports 606 for connecting to an outlet of the radionuclide generator. In this embodiment, each inlet port 604 and each outlet port 606 includes a septum configured to be pierced by a corresponding inlet needle or outlet needle of a radionuclide generator.

A plurality of eluate supply lines 608 are connected to the outlet ports 606 of the connection interface 506. Only a portion of each eluate supply line 608 is shown in FIG. 6. Further, a bubble sensor 610 is connected to each of the eluate supply lines 608 for detecting the presence of gas or bubbles within the respective eluate supply line 608.

Referring again to FIG. 5, in this embodiment, the fluid handling system 504 includes two eluant fluid sources 518, one for each of the connection interfaces 506, 510. Each of the eluant fluid sources 518 is connected to a respective one of the connection interfaces 506, 510 for supplying eluant fluid (e.g., saline) to each of the radionuclide generators 602 during elution. In this embodiment, each of the eluant fluid sources 518 includes a plurality of fluid reservoirs 520 for holding the eluant fluid, a pump (not shown in FIG. 5), and a fluid conduit 522 for supplying eluant fluid to the fluid reservoirs 520. The fluid reservoirs from the eluant fluid source 518 of the secondary connection interface 510 are not shown in FIG. 5.

As shown in FIG. 6, in this embodiment, the fluid reservoirs 520 are syringe barrels configured to hold a fixed amount of eluant fluid (e.g., 10 mL). Further, in this embodiment, each eluant fluid source 518 includes 8 fluid reservoirs 520, although other embodiments may include more or less than 8 fluid reservoirs. The fluid reservoirs 520 of the eluant fluid source 518 are connected in fluid communication with the radionuclide generators 602 via the connection interface 506. In this embodiment, the inlet of each radionuclide generator 602 is connected to a corresponding fluid reservoir 520 via the connection interface 506.

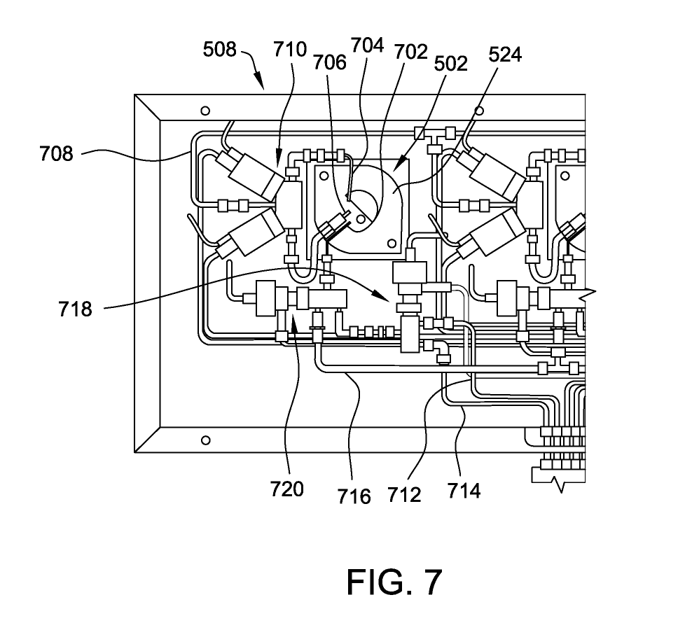

FIG. 7 is an enlarged view of one of the fluid handling subsystems 508 of the fluid handling system 504 shown in FIG. 5. With the exception of the vent line 336 and the associated venting operations, each of the fluid handling subsystems 508 includes substantially the same components and operates in substantially the same manner as the fluid handling system 306 described above with reference to FIG. 3. Specifically, in this embodiment, each fluid handling subsystem 508 includes a fluid supply line 702, a suction line 704, a fluid discharge line 706, a common discharge line 708, a first valve 710, a first eluate supply line 712, a second eluate supply line 714, a rinsing fluid supply line 716, a second valve 718, and a third valve 720. Each of the fluid supply line 702, the suction line 704, and the fluid discharge line 706 are fluidly connected to the collection reservoir of a corresponding radiation detection device 502. The first valve 710, the second valve 718, and the third valve 720 operate in the same manner as the first valve 334, the second valve 348, and the third valve 350 of the fluid handling system 306 described above with reference to FIG. 3 to carry out the fluid handling operations described herein.

In this embodiment, the eluate supply lines 712 and 714 of each fluid handling subsystem 508 are constructed of small inner diameter (e.g., ⅛ of an inch or less) tubing to minimize or reduce liquid hold up between the radionuclide generator 602 and the collection reservoir of a corresponding radiation detection device 502. Further, the tubing is sloped downward along the flow path to facilitate fluid flow towards the collection reservoir and to reduce or minimize liquid hold-up between the radionuclide generator 602 and the collection reservoir.

In this embodiment, the fluid handling system 504 includes a single vacuum pump. The vacuum pump is connected to the first valve 710 of each fluid handling subsystem 508 to enable selective fluid communication between the suction line 704 of each fluid handling subsystem 508 and the vacuum pump, and the fluid discharge line 706 of each fluid handling subsystem 508 and the vacuum pump.

In operation, each of the radionuclide generators 602 is connected to the fluid handling system 504 via the connection interface 506, and is eluted directly (i.e., without any intervening transfer vials or containers) into the collection reservoir of one of the radiation detection devices 502. In this embodiment, the controller of the assay system 500 controls operation of the fluid handling system 504 to simultaneously elute four of the radionuclide generators 602 directly into four corresponding radiation detection devices 502. Specifically, the controller controls operation of the first valve 710, the second valve 718, and the third valve 720 of each of the fluid handling subsystems 508, along with the vacuum pump, to elute four of the radionuclide generators 602, and deliver an eluate from each of the four radionuclide generator 602 into the collection reservoir of a respective radiation detection device 502.

Each of the radiation detection devices 502 then measures the radioactive content of the eluate within the corresponding collection reservoir, and the controller determines the radioactive content of each eluate based on the measurements taken by the radiation detection devices 502. In this embodiment, the radiation detection device 502 and/or the controller determines both a Molybdenum-99 content and a Technetium-99m content of each eluate. Once the assay process on the first four radionuclide generators is completed, the controller controls operation of the fluid handling system 504 to elute the other four radionuclide generators into four corresponding radiation detection devices to assay the remaining radiation nuclide generators.

Referring again to FIG. 5, in this embodiment, each radiation detection device 502 includes and/or is connected to a radiation-shielding plug 524 to prevent external radiation from entering the radiation detection device 502. The tops of the radiation-shielding plugs 524 are shown in FIGS. 5 and 7.

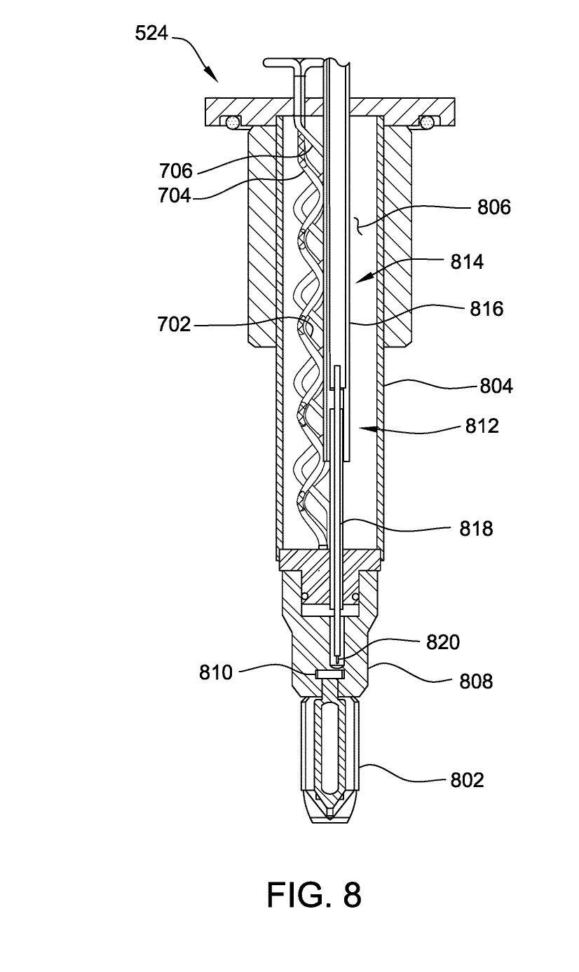

FIG. 8 is a sectional view of one of the radiation-shielding plugs 524 connected to a collection reservoir 802 of one of the radiation detection devices 502 shown in FIG. 5. The radiation-shielding plug 524 includes a cylindrical housing 804 constructed of radiation shielding material. Suitable radiation shielding materials from which the cylindrical housing 804 may be constructed include, for example and without limitation, lead, depleted uranium, and tungsten.

The cylindrical housing 804 has an interior cavity 806 through which the fluid supply line 702, the suction line 704, and the fluid discharge line 706 extend. The interior cavity 806 is filled with radiation shielding material (e.g., molten lead, not shown in FIG. 8) to provide radiation shielding. Further, as shown in FIG. 8, the point at which each of the lines 702, 704, 706 enters the plug 524 is axially offset relative to the point at which each of the lines 702, 704, 706 exits the plug to avoid forming a shine path that would allow external radiation to stream directly into the radiation detection device 502 and affect assay measurements.

In this embodiment, the collection reservoir 802 threads into a tungsten fixture 808, and seals against an elastomeric gasket 810. In other embodiments, the collection reservoir 802 may be connected to the radiation-shielding plug 524 using any suitable connection means. Further, in this embodiment, the collection reservoir 802 is constructed from Type 1 borosilicate glass, and is coated with a Diamon-Fusion coating to facilitate reducing adhesion of eluate to the collection reservoir 802. In other embodiments, the collection reservoir 802 may be constructed of other materials.

As shown in FIG. 8, each radiation detection device 502 also includes a constancy check device 812 to ensure proper functioning of the radiation detection device 502. In this embodiment, the constancy check device 812 includes a telescopic rod 814 that extends through the cylindrical housing 804. The telescopic rod 814 includes an outer rod 816 and an inner rod 818 that telescopes or moves relative to the outer rod 816. A radiation element or source 820 having a known level of radioactivity is connected to a distal end of the inner rod 818. In this embodiment, the radiation source 820 includes a Cesium-137 pellet. The inner rod 818 is moveable relative to the outer rod 816 between a retracted position (shown in FIG. 8), in which the radiation source 820 is positioned within the radiation-shielding plug 524, and an extended position in which the radiation source 820 is positioned within an ionization chamber of the radiation detection device.

When the radiation source 820 is positioned within the ionization chamber of the radiation detection device 502, the radiation detection device 502 measures the known radiation level of the radiation source 820. The known background radiation may be subtracted out of the radiation measurement to facilitate accurate measurement results. The radiation level measured while the radiation source 820 is positioned within the ionization chamber of the radiation detection device can be used to determine if the radiation detection device 502 is performing radiological measurements accurately (e.g., by comparing the measured values to the known level of radioactivity of the radiation source 820). In some embodiments, the constancy check device 812 is used to perform daily constancy checks.

Embodiments of the assay systems and methods described herein provide several advantages over known systems. For example, embodiments described herein facilitate assaying radionuclide generators without the use of transfer vials or containers, thereby reducing or eliminating costs associated with the manufacture and use of sterile evacuated vials typically used in performing assay procedures. Additionally, because transfer vials are not used, systems and methods of the present disclosure facilitate reducing solid radiological waste and remedial processing steps as compared to typical assay procedures. Further, embodiments of the systems and methods provide an automated assay procedure in which an automated fluid handling system elutes one or more radionuclide generators directly into a collection reservoir of radiation detection device, thereby eliminating multiple material handling steps associated with typical assay procedures that use transfer vials. Thus, embodiments of the systems described herein can operate autonomously, without personnel involvement. Additionally, embodiments of the vial-less assay systems and methods have relatively little or no moving parts as compared to systems that rely on transfer vials to assay radionuclide generators, which facilitates reducing or minimizing mechanical process failures. Further, embodiments of the systems and the methods described herein facilitate improving throughput by increasing the number of radionuclide generators that can be assayed within a given space and a given amount of time. For example, systems and methods described herein can process four radionuclide generators simultaneously, whereas typical, vial-based systems would have roughly half this throughput.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A system for assaying an eluate, the system comprising:
a radiation detection device including a collection reservoir, the radiation detection device adapted to measure a radioactive content of a sample within the collection reservoir;
a fluid handling system for delivering fluid to the collection reservoir, the fluid handling system including a fluid supply line, a suction line, and a fluid discharge line, each line connected to the collection reservoir; and
a connection interface for connecting a radionuclide generator to the collection reservoir via the fluid handling system;
wherein the fluid handling system is configured to generate a negative pressure within the collection reservoir via the suction line such that an eluate from the radionuclide generator is supplied to the collection reservoir via the fluid supply line.

2. The system of claim 1, wherein the fluid discharge line extends into the collection reservoir and adjacent a lower surface of the collection reservoir for removing fluid from the collection reservoir.

3. The system of claim 1, wherein the suction line includes an inlet positioned within the collection reservoir and above a liquid reference line within the collection reservoir.

4. The system of claim 1, wherein the connection interface includes an inlet port for connecting to an inlet of a radionuclide generator and an outlet port for connecting to an outlet of the radionuclide generator.

5. The system of claim 4, wherein the outlet port includes a septum for connecting to an outlet needle of the radionuclide generator.

6. The system of claim 4, further comprising an eluate supply line connected to the outlet port of the connection interface, and selectively connectable to the fluid supply line by actuation of at least one actuatable valve.

7. The system of claim 6, further comprising a sensor connected to the eluate supply line, wherein the sensor is configured to detect the presence of gas within the eluate supply line.

8. The system of claim 1, further comprising a pump connected to the suction line, wherein operation of the pump generates the negative pressure within the collection reservoir.

9. The system of claim 1, further comprising a first eluate supply line, a second eluate supply line, and at least one actuatable valve connected between each of the first and second eluate supply lines and the fluid supply line, wherein the first and second eluate supply lines are selectively connectable to the fluid supply line by actuation of the at least one valve to supply eluate to the collection reservoir from different radionuclide generators.

10. The system of claim 1, further comprising a rinsing fluid supply line and at least one actuatable valve connected between the rinsing fluid supply line and the fluid supply line, wherein the rinsing fluid supply line is selectively connectable to the fluid supply line by actuation of the at least one valve to supply rinsing fluid to the collection reservoir.

11. The system of claim 1, wherein the radiation detection device includes an ionization chamber for measuring at least one of a Molybdenum-99 content and a Technetium-99m content of the eluate.

12. The system of claim 1 in combination with the radionuclide generator.

13. The system of claim 12, wherein the radionuclide generator is directly connected to the collection reservoir via the fluid handling system without an intermediate liquid container.

14. A method of assaying an eluate comprising:
connecting a radionuclide generator to a connection interface of a fluid handling system, the fluid handling system including a fluid supply line, a suction line, and a fluid discharge line, each line connected to a collection reservoir of a radiation detection device;
eluting the radionuclide generator to produce an eluate, wherein eluting the radionuclide generator includes generating a negative pressure within the collection reservoir via the suction line;
directing the eluate into the collection reservoir via the fluid supply line;
determining, using a processor, a radioactive content of the eluate; and
discharging the eluate from the collection reservoir via the fluid discharge line.

15. The method of claim 14, wherein the radionuclide generator is a first radionuclide generator, the method including connecting a second radionuclide generator to the connection interface while the first radionuclide generator is connected to the connection interface.

16. The method of claim 15 further including selectively connecting one of the first and second radionuclide generators in fluid communication with the collection reservoir by actuating at least one valve.

17. The method of claim 14, wherein connecting a radionuclide generator to a connection interface includes piercing a septum of the connection interface with one of an inlet needle and an outlet needle of the radionuclide generator.

18. The method of claim 14, wherein the fluid handling system further includes an eluate supply line connected between the radionuclide generator and the fluid supply line, the method including:
detecting, using a sensor, the presence of gas within the eluate supply line; and
ceasing elution of the radionuclide generator based upon the detection of gas within the eluate supply line.

19. The method of claim 14, further including:
selectively connecting a rinsing fluid supply line to the fluid supply line by actuation of at least one actuatable valve; and
supplying rinsing fluid to the collection reservoir via the rinsing supply line.

20. The method of claim 19 further including:
selectively connecting the fluid discharge line to a vent line; and
generating a negative pressure within the collection reservoir via the suction line such that gas is drawn through the fluid discharge line and through the rinsing fluid within the collection reservoir.

21. The method of claim 14, wherein determining, using a processor, a radioactive content of the eluate includes determining, using the processor, a Molybdenum-99 content and a Technetium-99m content of the eluate.
